(19) United States
(12) Patent Application Publication
(10) Pub. No.: US 2026/0084439 A1
(43) Pub. Date: Mar. 26, 2026

(54) PIECE OF EQUIPMENT AND PROCESS FOR THE DECORATION OF CERAMIC MANUFACTURED ARTICLES

(71) Applicant: TECNO ITALIA DIGITAL S.R.L., Fiorano Modenese (MO) (IT)

(72) Inventors: Andrea PALLADINI, Fiorano Modenese (MO) (IT); Dino BOCCACCINI, Fiorano Modenese (MO) (IT); Fabio TONI, Fiorano Modenese (MO) (IT)

(21) Appl. No.: 19/112,817

(22) PCT Filed: Sep. 20, 2023
(86) PCT No.: PCT/IB2023/059304

§ 371 Date: Mar. 18, 2025

(30) Foreign Application Priority Data
Sep. 23, 2022 (IT) 102022000019578

(51) Int. Cl. B41J 3/407; B28B 11/00; B28B 11/04; B41M 5/00; B41M 7/00; C04B 41/86; C04B 41/89

(52) U.S. Cl. CPC B41J 3/407; B28B 11/001; B28B 11/044; B28B 11/048; B41M 5/0047; B41M 5/007; B41M 7/009; C04B 41/86; C04B 41/89

(57) ABSTRACT

The process for the decoration of ceramic manufactured articles, comprises at least the following phases of:—supply of at least one ceramic medium(S) to be decorated having at least one exposed surface (“Sa”) and at least one laying surface (“Sb”) opposite each other;—application by means of a first printer, preferably a first digital inkjet printer (4), of a water-repellent liquid (L) on the exposed surface (“Sa”) according to a predefined design (D);—spreading of a water-based glaze (C) on the exposed surface (Sa), wherein the spreading is earned out by means of a dispensing device (5);—application by means of a second printer, preferably a second digital inkjet printer (10), of at least one ceramic ink on the exposed surface (Sa) with a design which is coordinated to the predefined design (D).

### TECHNICAL FIELD

The present invention relates to a piece of equipment and a process for the decoration of ceramic manufactured articles, such as ceramic tiles and/or slabs.

### BACKGROUND ART

To date, there is a widespread need in the ceramic industry for new surface effects which are increasingly closer to natural stone or otherwise of a textured type, that is, with reliefs and/or depressions to define a three-dimensional effect.

The owner noted that these kinds of effects are generally obtained during the forming stage of the manufactured article, that is, during the process of pressing the ceramic powders which leads to a ceramic medium.

The forming stage is carried out by using a pad or a roller or an engraved tape, which, in the case of textured effects, have respective pressing surfaces provided with reliefs and/or depressions reproducing the negative side of the effect to be obtained.

In this way, the resulting ceramic medium itself has a textured exposed surface, which will then be covered by the glaze applied in the subsequent stages of decoration.

The owner noted that these processes, as well as the related equipment, do however have a number of drawbacks.

They, in fact, are characterized by limited flexibility of use because, with a single piece of equipment, ceramic media are obtained that all have the same surface structure.

It is therefore evident that it is necessary to provide oneself with a plurality of differently shaped engraved pads and/or rollers and/or tapes in order to obtain ceramic manufactured articles having different aesthetic effects, and that this entails high investments, which hardly find justification, particularly in the case of small to medium production batches.

In any case, even if a large number of differently engraved pads and/or rollers and/or tapes were available, the number of aesthetic effects which could be achieved would still remain limited and their replacement would result in high downtimes and, consequently, low production yields.

The owner noted that other technologies of known type involve the application, on the exposed surface of the ceramic medium, of an adhesive material on which a granular material is subsequently deposited, being in relief from the exposed surface itself. The excess granular material must then be subsequently taken off. According to the owner, the limitation of this technology consists particularly in that it does not allow for high definitions, so the resulting textured effect is less sharp and defined than the methodology described above.

A further technology of known type which is known to the owner involves the application on the exposed surface of a water-repellent liquid on top of which a glaze is then applied which, since it contains water, accumulates on the areas without the water-repellent liquid, thus obtaining a textured effect.

In the owner's opinion, however, this known technology also has some drawbacks due to the fact that the glaze dispensing devices generally used, such as e.g. airless spray guns, on the one hand involve the use of glazes with little or no water content, thus making the effect of the water-repellent liquid blurry or imperceptible and, on the other hand, result in the application of a suboptimal amount of glaze, which causes a flattening effect on the structure.

In the following description, the expression water-repellent liquid generically refers to a hydrophobic liquid or a reserving liquid.

A further drawback of the prior art turns out to be the absence of a coincidence of the design of the textured surface with the images that are printed thereon. In fact, in the prior art, the relief parts do not coincide at all with the graphics printed on the tile, and this causes an effect of irregularity.

### DESCRIPTION OF THE INVENTION

The main aim of the present invention is to devise a process and a piece of equipment which allow ceramic manufactured articles with a textured surface effect to be obtained in a smooth and flexible manner, where the graphics applied thereon turn out to be coordinated with the design of the textured surface.

Within this aim, one object of the present invention is to achieve a plurality of different structured aesthetic effects with a single piece of equipment.

Another object of the present invention is to devise a process and a piece of equipment which allow achieving high surface and three-dimensional definition of the structure defined on the manufactured articles thus decorated.

Still another object of the present invention is to optimize the amount of glaze which is applied in the stages of the decoration of the ceramic medium, so as to reduce the material usage and related costs to the necessary minimum, while at the same time avoiding the flattening of the three-dimensional structured effect. Another object of the present invention is to devise a piece of equipment and a process for the decoration of ceramic manufactured articles which allows the aforementioned drawbacks of the prior art to be overcome within the framework of a simple, rational, easy and effective to use as well as cost-effective solution. In the following description, the term “glaze” refers, for simplicity's sake, to an aqueous suspension which comprises both transparent and colored engobes or vitrified glazes. In other words, the term glaze refers to any aqueous suspension useful for the surface treatment of the ceramic medium.

A process for the decoration of ceramic manufactured articles according to the present invention preferably comprises at least one or more of the following phases of:
supply of at least one ceramic medium to be decorated having at least one exposed surface and at least one laying surface opposite each other;
application by means of a first printer, preferably a first digital inkjet printer, of a water-repellent liquid on the exposed surface according to a predefined design; spreading of a water-based glaze on the entire area of the exposed surface, wherein spreading is carried out by means of a dispensing device;
application by means of a second printer, preferably a second digital inkjet printer, of a ceramic ink on the exposed surface with a design which is coordinated to the predefined design.

Preferably, the process comprises an additional phase of firing of the ceramic medium in order to obtain a decorated ceramic manufactured article.

Preferably, an additional protective glaze can be applied onto the entire surface of the ceramic medium before firing.

Preferably, the glaze dispensing device comprises an internally hollow container for the collection of the glaze provided with at least one set of through orifices for the outflow of the glaze.

Preferably, the dispensing device comprises at least one roller housed within the container and operable in rotation around a relevant axis.

Preferably, the roller is provided with a set of projections angularly spaced away from each other along the circular development of the roller itself which are adapted to open and close the orifices in a sequential and cyclic manner to allow and prevent, respectively, the outflow of the glaze from the container.

Preferably, glaze spreading is carried out in a single pass.

Preferably, glaze spreading is carried out using a single color.

Preferably, the coordinated design is complementary to the predefined design.

Preferably, the process according to the present invention comprises the further phases of: generating a first electronic datum representative of the predefined design and processing the result of the first electronic datum to obtain a second electronic datum representative of the coordinated design.

Preferably, the process also comprises an additional phase of spreading at least one ceramic glaze and/or engobe over the entire area of the exposed surface before the application of the water-repellent liquid.

Preferably, the water-repellent liquid comprises at least one silicone component. A piece of equipment for the decoration of ceramic manufactured articles according to the present invention preferably comprises at least one or more of the following characteristics:
a movement line of at least one ceramic medium to be decorated along one direction of forward movement, wherein the ceramic medium has at least one exposed surface and at least one laying surface opposite each other;
at least one first printer, preferably a first digital inkjet printer, for the application of a water-repellent liquid onto the exposed surface according to a predefined design;
a dispensing device of a water-based glaze, arranged downstream of the first digital printer along the direction of forward movement for the spreading of the glaze over the entire area of the exposed surface;
at least one second printer, preferably a second digital inkjet printer, arranged downstream of the dispensing device along the direction of forward movement and adapted to dispense at least one ceramic ink on the exposed surface with a design which is coordinated to the predefined design.

Preferably, the piece of equipment comprises a kiln for the firing of the ceramic medium arranged downstream of the second digital printer along the direction of forward movement to obtain a decorated ceramic manufactured article.

Preferably the piece of equipment comprises, between the second printer and the firing kiln, a glaze dispensing device for dispensing glaze over the entire surface of the manufactured article.

Preferably, the dispensing device comprises an internally hollow container for the collection of the glaze provided with at least one set of through orifices for the outflow of the glaze, and at least one roller housed within the container and operable in rotation around a relevant axis, the roller being provided with a set of projections angularly spaced away from each other along the circular development of the roller itself, which are adapted to open and close the orifices in a sequential and cyclic manner to allow and prevent, respectively, the outflow of the glaze from the container.

Preferably, the piece of equipment comprises at least one control and command unit operatively connected to at least the digital printers and provided with at least one processing unit comprising first generation means for generating at least one first electronic datum representative of the predefined design and second generation means for generating one second electronic datum representative of the coordinated design.

Preferably, the first generation means for generating the first electronic datum and the second generation means for generating the second electronic datum are operatively connected to each other.

Preferably, the control and command unit comprises a programmable memory operatively connected to the processing unit.

Preferably, the command and control unit is built into at least one of the digital printers.

### BRIEF DESCRIPTION OF THE DRAWINGS

Other characteristics and advantages of the present invention will become more apparent from the description of a preferred, but not exclusive, embodiment of the piece of equipment and process for the decoration of ceramic manufactured articles, illustrated by way of an indicative yet non-limiting example, in the accompanying tables of drawings wherein:

FIG. 1 is an axonometric schematic representation of a piece of equipment according to the present invention;

FIG. 2 is a cross-sectional view of a ceramic medium during the application phase of a water-repellent liquid in carrying out a process according to the invention;

FIG. 3 is a cross-sectional view of a ceramic medium following the application phase in FIG. 2, according to the track line III-III in FIG. 1;

FIG. 4 is a cross-sectional view of a ceramic medium during the spreading phase of a glaze in carrying out a process according to the invention;

FIG. 5 is a cross-sectional view of a ceramic medium following the spreading phase in FIG. 4, according to the track line V-V in FIG. 1;

FIG. 6 is a cross-sectional view of a ceramic medium during the application phase of a ceramic ink in carrying out a process according to the invention;

FIG. 7 is a cross-sectional view of a ceramic medium following the application phase in FIG. 6, according to the track line VII-VII in FIG. 1.

### EMBODIMENTS OF THE INVENTION

With particular reference to these figures, reference numeral 1 globally denotes a piece of equipment for the decoration of ceramic manufactured articles.

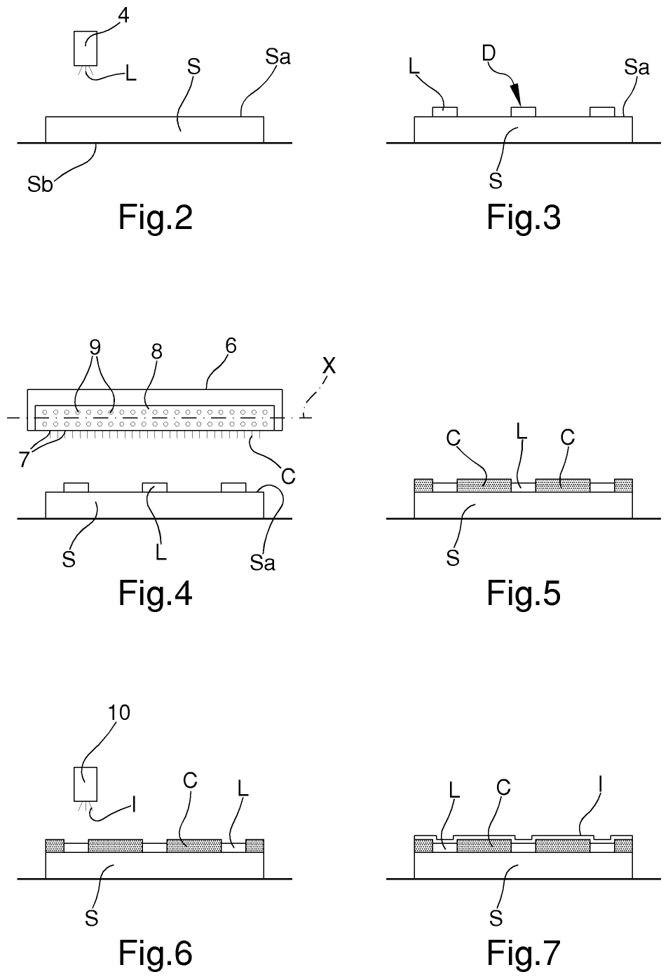

The piece of equipment 1, according to a preferred yet non-exclusive embodiment, comprises a movement line 2 of at least one ceramic medium S to be decorated along one direction of forward movement 3, wherein the ceramic medium S has at least one exposed surface “Sa” and at least one laying surface “Sb” opposite each other, as shown in FIG. 2. The movement line 2 defines a resting plane of the ceramic medium S and consists e.g. of a plurality of motorized belts.

The piece of equipment 1 then comprises, at least one first printer, preferably a first digital inkjet printer 4, schematically shown in the figures, for the application of a water-repellent liquid L on the exposed surface “Sa” according to a predefined design identified in the figures with reference letter D.

The water-repellent liquid L is characterized by having the property of preventing water-based ceramic engobes and/or glazes from subsequently adhering to the areas onto which the liquid itself is applied. In other words, in the areas of application of the water-repellent liquid L on the exposed surface “Sa” of the ceramic medium S, the engobes and/or glazes do not adhere onto the surface “Sa” itself and thus do not overlap with the water-repellent liquid. This no overlapping causes a difference in thickness between the areas where the water-repellent liquid is applied and the areas lacking it. The latter areas will be, at the end of the process described herein, provided with a greater thickness than the other areas onto which the engobes and/or glazes have not substantially adhered.

More particularly, the water-repellent liquid L comprises at least one silicone component, that is, a component consisting of silicone or a mixture of several different silicones.

Downstream of the first digital printer 4, along the direction of forward movement 3, a dispensing device 5 of a glaze C, typically water-based, is provided. The dispensing device 5 is adapted to dispense the glaze C onto the exposed surface “Sa”, preferably over its entire area.

Preferably, the dispensing device 5 comprises an internally hollow container 6 for the supply of the glaze C to at least one set of through orifices 7 to put the inside of the container 6 in fluid communication with the outside of the container 6, thus allowing the glaze C to flow out.

Preferably, the dispensing device 5 also comprises at least one roller 8 housed within the container 6 and operable in rotation around a relevant axis X. Appropriately, the roller 8 is provided with a set of projections 9 angularly spaced away from each other along the circular development of the roller itself, which are adapted to open and close the orifices 7 in a sequential and cyclic manner to allow and prevent, respectively, the transit of the glaze C from inside the container 6 to outside thereof, thus causing the glaze C to flow out in the form of a succession of droplets generated through the orifices 7.

More particularly, the projections 9 are angularly spaced away from each other along the circular development of the roller 8 so as to open and close the orifices 7 in a sequential and cyclic manner during the rotation of the roller itself. Therefore, glaze droplets are dispensed through the orifices 7, resulting in a substantially punctiform and even application on the ceramic medium S. As the opening time of the orifices 7 varies, the size of the dispensed droplet varies too. Thus, if the opening time of the orifices 7 increases, the size of the dispensed droplet increases. Appropriately, the orifices 7 are aligned with each other parallel to the longitudinal development of the container 6.

The dispensing device 5 is then adapted to spread an even layer of glaze C on the exposed surface “Sa” in a single pass. In other words, a single droplet of glaze C is dispensed on each area of the exposed surface “Sa” and the ceramic medium S, transiting below the dispensing device 5 once, is entirely covered with the glaze C.

The glaze C, once deposited on the exposed surface “Sa” is “rejected” by the water-repellent liquid L moving away from the areas where it was previously applied and thus accumulating in the areas of the exposed surface “Sa” not involved by the predefined design D. This results in an accumulation of the glaze C in the areas of the exposed surface “Sa” outside the predefined design D. This creates a difference in thickness of the areas with the glaze C compared to the areas making up the same predefined design D. As a result of the application of the glaze C, a textured effect is thus obtained on the exposed surface “Sa”.

According to the present invention, the piece of equipment 1 comprises at least one second printer, preferably a second digital inkjet printer 10, arranged downstream of the dispensing device 5 along the direction of forward movement 3 and adapted to dispense one or more ceramic inks I on the areas of the exposed surface “Sa”, according to a design which is coordinated to the predefined design D.

It cannot, however, be ruled out that in an alternative embodiment the first digital printer 4 and the second digital printer 10 may coincide with each other and, therefore, the movement line 2 may move the ceramic medium S along the direction of forward movement 3 in either way.

In use, the predefined design D is the result of a print, by the first digital printer 4, of a processed image which is electronically derived from a reference image, which, in turn, will be used to also be printed using the ceramic ink I with the second digital printer 10.

Thus, ceramic ink I is dispensed by the second digital printer 10 depending on the predefined design D with which the water-repellent liquid L has been applied. The second digital printer 10 can, e.g., dispense the ceramic ink I only on the areas outside the predefined design D, i.e., on the areas complementary thereto, overlapping the relief areas obtained with the accumulation of the previously deposited glaze C. Or, the second digital printer 10 can dispense ceramic inks of a first type on the areas outside the predefined design D and ceramic inks of a second type, different from the first type, on the predefined design itself. In other words, the second digital printer 10 can make designs which are coordinated with the first digital printer 4.

It cannot, however, be ruled out that the second digital printer 10 can dispense the ceramic ink I over the entire area of the exposed surface “Sa”. In this case, the coordinated design then corresponds to a full field, i.e., to the entire area of the exposed surface “Sa”.

Preferably, the piece of equipment 1 comprises at least one control and command unit 11 operatively connected at least to the digital printers 4 and 10 and provided with a processing unit 12, of the type of a microprocessor, comprising first generation means 13 for generating at least one first electronic datum representative of the predefined design D and second generation means 14 for generating one second electronic datum representative of the coordinated design to be applied onto the exposed surface “Sa”. The first generation means 13 for generating the first electronic datum and the second generation means 14 for generating the second electronic datum are operatively connected to each other. Preferably, the second generation means 14 for generating the second electronic datum are adapted to process the first electronic datum received from the first generation means 13.

Appropriately, the control and command unit 11 also comprises a programmable memory 15 operatively connected to the processing unit 12.

The predefined design D can then be selected from those stored in the programmable memory 15 or randomly defined from time to time by the processing unit 12.

More particularly, the first generation means 13 for generating the first electronic datum are operatively connected to the first digital printer 4 and the second generation means 14 for generating the second electronic datum are operatively connected to the second digital printer 10.

The control and command unit 11 can be built into one or both of the digital printers 4 and 10 or can be remotely connected thereto.

Appropriately, the control and command unit 11 is also operatively connected to the dispensing device 5 so as to adjust the rotational speed of the roller 8 according to the optimal amount of glaze to be spread onto the exposed surface “Sa”.

The piece of equipment 1 then comprises a kiln 16 for the firing of the ceramic medium S, arranged downstream of the second digital printer 10 along the direction of forward movement 3, to obtain a decorated ceramic manufactured article M.

Preferably downstream of the second printer 10 and before the kiln 16 an additional layer of glaze is applied onto the entire surface of the ceramic medium S, which glaze can be applied either by an additional dispensing device 5 and/or by a bell system and/or by an airless system.

In use, according to a preferred yet non-exclusive embodiment of the present piece of equipment 1 in the execution of the process according to the invention, the operation is as described below.

The process covered by the present invention comprises first of all the supply of a ceramic medium S to be decorated provided with an exposed surface “Sa”, intended in use to face outwards, and a laying surface “Sb”, opposite the exposed surface “Sa” and intended, in use, to be laid on a reference surface, such as a floor or wall.

The ceramic medium S can have a variety of sizes, i.e., it can be of the type of a ceramic tile, and thus generally characterized by dimensions of less than 1 meter (e.g. 30×30 cm, 60×60 cm, etc.) or of the type of a ceramic slab, i.e., characterized by dimensions that can reach over 3 meters.

The ceramic medium S is obtained by forming, that is, by compacting a mass of ceramic powders, in a manner known to the engineer in the field. In particular, the ceramic medium formed as supplied does not comprise any variation in thickness to represent a predefined design, and its exposed surface “Sa” is substantially flat.

According to the present invention, the process then involves the application of the water-repellent liquid L by means of the first digital printer 4 according to the predefined design D.

In a special embodiment, it is also possible to carry out a phase of spreading at least one ceramic engobe over the entire area of the exposed surface “Sa” before the application of the water-repellent liquid L.

Following the application of the water-repellent liquid L, the glaze C is applied over the entire area of the exposed surface “Sa”. Preferably, this phase of spreading the glaze C is carried out by means of the dispensing device 5.

As mentioned above, the dispensing device 5 is adapted to intermittently dispense, with a variable frequency depending on the speed of the roller 8 and on the size of the projections 9, a plurality of droplets of glaze C on the exposed surface “Sa” of the ceramic medium S transiting under it, so as to achieve a homogeneous and even spreading of the glaze C on the same exposed surface “Sa”.

Advantageously, spreading of the glaze C is carried out in a single pass, that is, in one go and of a single type, and with a single color, preferably a light color, transparent or white.

As specified earlier, the term “glaze” also generically includes any aqueous suspension such as engobe or vitrified glaze.

The glaze C dispensed by the dispensing device 5 then deposits on the exposed surface “Sa” by covering, at first, also the predefined design D. Due to the characteristics of the water-repellent liquid L, however, the glaze C moves away from the areas onto which the water-repellent liquid itself has been applied, that is, from the predefined design D, thus accumulating in the areas around it. In other words, the glaze C distributed by the dispensing device 5 accumulates on the areas not affected by the predefined design D due to the surface tension of water the glaze C itself is composed of.

As a result of the spreading of the glaze C, there is, therefore, a difference in thickness, and thus in level, between the areas onto which the water-repellent liquid L had been applied and the areas not affected by that application, where the glaze C accumulates. It follows, therefore, that the areas initially unaffected by the application of the water-repellent liquid L have greater height than the areas affected by the predefined design D, which thus results in bas-relief.

Following the spreading of the glaze C, a ceramic ink I is applied onto the ceramic medium S. Specifically, a design is printed on the exposed surface “Sa” by means of the second digital printer 10, which design should be coordinated with the predefined design D. Preferably, the design made by means of the ceramic ink I will overlap both the portion of the exposed surface “Sa” affected by the predefined design D and the portion of the exposed surface “Sa” affected by the glaze C.

The positioning, orientation and application of the image made by the ceramic ink I printed on the ceramic medium S depend therefore on the geometry and spatial distribution of the predefined design on the exposed surface “Sa”. In this way, the shapes of the reliefs on the exposed surface “Sa” will coincide with the shapes and lines of the final tile print.

In a particular embodiment, the coordinated design according to which the ceramic ink I is applied can be complementary to the predefined design D, that is, the ceramic ink I is applied only in the areas of the exposed surface “Sa” outside the predefined design itself by overlapping with the relief areas obtained by the accumulation of the previously deposited glaze C.

In another embodiment, however, the second digital printer 10 provides for applying different types of ceramic ink I onto the areas outside the predefined design D and onto the predefined design itself.

In more detail, the process according to the invention comprises the phase of supplying a reference image selected from a very large number of digital images from which then to implement the sub-phases of generating a first electronic datum representative of the predefined design D and of processing the first electronic datum to obtain a second electronic datum representative of the coordinated design. The first electronic datum and the second electronic datum are handled by the first digital printer 4 and by the second digital printer 10, respectively.

The generation and processing of the first electronic datum are carried out by the control and command unit 11 described above.

The process according to the invention may comprise an additional phase of application of an additional layer of glaze onto the surface of the ceramic medium, which can be applied either by means of an additional dispensing device 5 and/or a bell system and/or an airless system.

Finally, the process according to the invention comprises one phase of firing of the ceramic medium S so as to obtain a decorated ceramic manufactured article M.

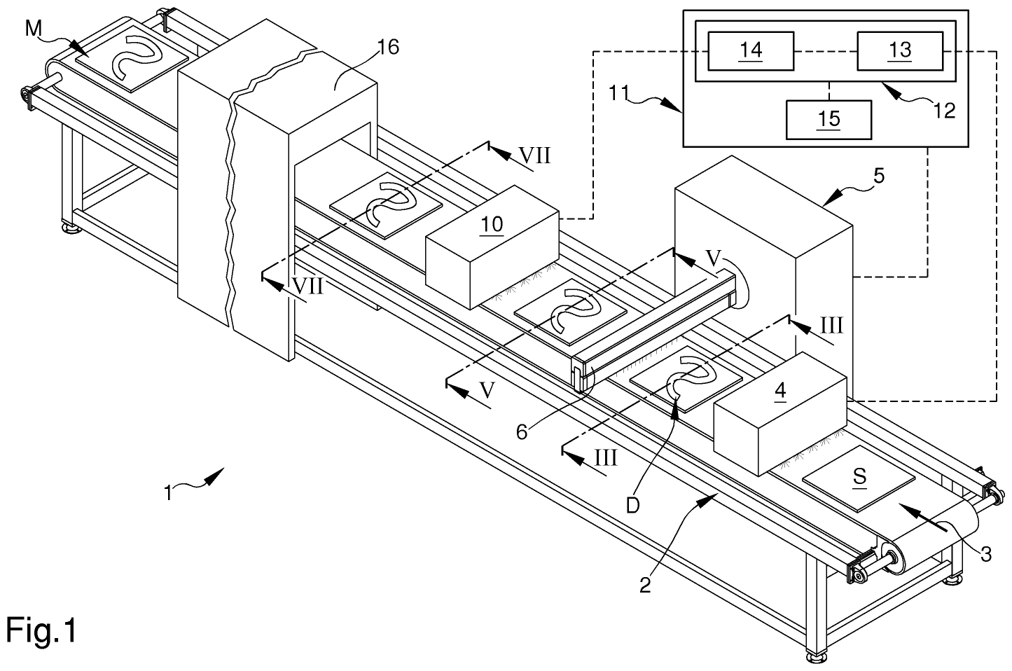

The phase of firing is carried out using a ceramic kiln of a type known to the technician in the field, schematically shown in FIG. 1 and identified by reference number 16.

It has in practice been ascertained that the above-described piece of equipment and process achieve the intended objects, and in particular, the fact is emphasized that the combination of the application of a water-repellent liquid by means of digital printing, the spreading of a water-based glaze by means of a glaze dispensing device comprising a hollow container within which a roller is arranged in a revolving manner so as to dispense droplets of glaze resulting in a punctiform application on the medium, and the application of a ceramic ink by means of digital printing according to a design coordinated with the previous application of the water-repellent liquid, make it possible to achieve a textured effect on the exposed surface of the manufactured article thus decorated while maintaining high definition.

In particular, the spreading of an even layer of glaze on the exposed surface of the ceramic support to be decorated by means of a single pass and according to the methods described above allows obtaining a high-quality three-dimensional effect. In fact, the amount of glaze applied turns out to be a factor of primary importance in obtaining a high definition of the surface structure: this is because too small an amount would lead to an imperceptible difference in the relief obtained, while an excessive amount of glaze would dampen the liquid's water-repellent efficacy and, consequently, the textured effect would also be poorly marked.

In addition, the quality of the three-dimensional effect with the use of reliefs and bas-reliefs is most appreciated when this is combined with image graphics that are made with a high definition, preferably achievable with a digital printer, and even more preferably with printers with a definition level above 150 DPI (dots per inch). This methodology and piece of equipment can make it possible to faithfully reproduce the shapes of the grain of a stone, marble or the veins of a wood, e.g., by providing not only a pleasing aesthetic appearance but also a tactile pleasantness. This makes the ceramic medium S very similar to the objects depicted thereon with images, thus generating a special appreciation by the end users.

Again, the development of a design coordinated with the predefined design according to which the water-repellent liquid is applied enables the realization of aesthetic effects that cannot be achieved by the processes and equipment known to date.

1. Process for the decoration of ceramic manufactured articles, characterized by the fact that it comprises at least the following phases of:
supply of at least one ceramic medium(S) to be decorated having at least one exposed surface (“Sa”) and at least one laying surface (“Sb”) opposite each other;
application by means of a first printer, preferably a first digital inkjet printer (4), of a water-repellent liquid (L) on said exposed surface (“Sa”) according to a predefined design (D);
spreading of a water-based glaze (C) on the exposed surface (Sa), wherein said spreading is carried out by means of a dispensing device (5) comprising
an internally hollow container (6) for the collection of the glaze (C) provided with at least one set of through orifices (7) for the outflow of the glaze (C), and
at least one roller (8) housed within said container (6) and operable in rotation around a relevant axis (X), said roller (8) being provided with a set of projections (9) angularly spaced away from each other along the circular development of the roller itself adapted to open and close said orifices (7) in a sequential and cyclic manner to allow and prevent respectively the outflow of the glaze (C) from said container (6);
application by means of a second printer, preferably a second digital inkjet printer (10), of at least one ceramic ink on said exposed surface (Sa) with a design which is coordinated to said predefined design (D).

2. Process according to claim 1, characterized by the fact that it comprises, subsequent to said application of at least one ceramic ink at least one phase of firing of said ceramic medium (S) to obtain a decorated ceramic manufactured article (M).

3. Process according to claim 1, characterized by the fact that said spreading is carried out in a single pass.

4. Process according to claim 1, characterized by the fact that said spreading is carried out using a single color.

5. Process according to claim 1, characterized by the fact that said coordinated design is complementary to said predefined design (D).

6. Process according to one claim 1, characterized by the fact that it comprises the further phases of:
generating a first electronic datum representative of said predefined design (D);
processing the result of said first electronic datum to obtain a second electronic datum representative of said coordinated design.

7. Process according to claim 1, characterized by the fact that it comprises a phase of spreading at least one ceramic engobe over the entire area of said exposed surface (Sa) before the application of the water-repellent liquid (L).

8. Process according to claim 1, characterized by the fact that said water-repellent liquid (L) comprises at least one silicone component.

9. Piece of equipment (1) for the decoration of ceramic manufactured articles, characterized by the fact that it comprises:
a movement line (2) of at least one ceramic medium(S) to be decorated along one direction of forward movement (3), where the ceramic medium(S) has at least one exposed surface (Sa) and at least one laying surface (“Sb”) opposite each other;
at least one first digital inkjet printer (4) for the application of a water-repellent liquid (L) onto said exposed surface (Sa) according to a predefined design (D);
a dispensing device (5) of a water-based glaze (C), arranged downstream of said first digital printer (4) along said direction of forward movement (3) for the spreading of the glaze (C) on said exposed surface (Sa) and comprising:
an internally hollow container (6) for the collection of the glaze (C) provided with at least one set of through orifices (7) for the outflow of the glaze (C), and
at least one roller (8) housed within said container (6) and operable in rotation around a relevant axis (X), said roller (8) being provided with a set of projections (9) angularly spaced away from each other along the circular development of the roller itself adapted to open and close said orifices (7) in a sequential and cyclic manner to allow and prevent respectively the outflow of the glaze (C) from said container (6);
at least one second digital inkjet printer (10), arranged downstream of said dispensing device (5) along said direction of forward movement (3) and adapted to dispense at least one ceramic ink (I) on said exposed surface (Sa) with a design which is coordinated to said predefined design (D).

10. Piece of equipment according to claim 9, characterized by the fact that it comprises at least one kiln (16) for the firing of said ceramic medium(S) arranged downstream of said second digital printer along said direction of forward movement (3) to obtain a decorated ceramic manufactured article (M).

11. Piece of equipment (1) according to claim 9, characterized by the fact that it comprises at least one control and command unit (11) operatively connected at least to said digital printers (4, 10) and provided with at least one processing unit (12) comprising first generation means (13) for generating at least one first electronic datum representative of said predefined design (D) and second generation means (14) for generating a second electronic datum representative of said coordinated design.

12. Piece of equipment (1) according to claim 11, characterized by the fact that said first generation means (13) for generating the first electronic datum and said second generation means (14) for generating the second electronic datum are operatively connected to each other.

13. Piece of equipment (1) according to claim 11, characterized by the fact that said control and command unit (11) comprises a programmable memory (15) operatively connected to said processing unit (12).

14. Piece of equipment (1) according to claim 11, characterized by the fact that said control and command unit (11) is built into at least one of said digital printers (4, 10).
